(19) United States
(12) Patent Application Publication
(10) Pub. No.: US 2006/0104200 A1
(43) Pub. Date: May 18, 2006

(54) Terminal for automatically changing operating mode and wireless network system having the same, and method thereof

(75) Inventor: Jae-Hyun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/274,394

(22) Filed: Nov. 16, 2005

(30) Foreign Application Priority Data
Nov. 18, 2004 (KR) 2004-0094744

(51) Int. Cl. H04J 1/16

(52) U.S. Cl. 370/216

(57) ABSTRACT

A terminal for automatically changing a communication mode, a wireless network system having the same, and a method thereof are disclosed. The terminal comprises a wireless communication module for communicating with a corresponding terminal through an access point connected to a communication infrastructure. The terminal further comprising a first memory for storing Ad-Hoc information previously established between the terminal and the corresponding terminal, and a controller for controlling the wireless communication module to communicate with the corresponding terminal based on an Ad-Hoc communication mode using the Ad-Hoc information stored in the first memory when the network access point has malfunctioned.

### CROSS-REFERENCE TO RELATED APPLICATIONS

This application claims the benefit under 35 U.S.C. § 119(a) of Korean Patent Application No.10-2004-0094744, filed Nov. 18, 2004, in the Korean Intellectual Property Office, the entire disclosure of which is hereby incorporated by reference.

### BACKGROUND OF THE INVENTION

1. Field of the Invention

The present invention relates to a method and apparatus for automatically changing a communication mode and a wireless network system having the same. More particularly, the present invention relates to a terminal for automatically changing a communication mode from an infrastructure communication mode to an Ad-Hoc communication mode when an access point has malfunctioned and a wireless network system having the same, and method thereof.

2. Description of the Related Art

High-speed wireless networks have been gradually introduced to daily life. In high-speed wireless networks, a network environment is built using a radio wave or light without using wires, such as coaxial cable. It is handy to build a wireless network since wiring is not required to build the wireless network. The wireless network also allows high-speed data communication within a range of data transmission speeds from 11 Mbps to 54 Mbps using wideband radio waves from 2.4 GHz to 5 GHz. There are many technologies available to build a wireless communication network and to transfer data through the wireless communication network. Among the technologies available, an Ad-Hoc communication mode and an infrastructure communication mode are representative of commonly used wireless communication methods. The Ad-Hoc communication mode is generally used for notebook computers communicating through a wireless communication channel using a wireless local area network (LAN) card. The infrastructure communication mode uses an access point (AP) as a bridge between a wireless communication network and a wired communication network.

FIG. 1A illustrates a wireless communication system employing an Ad-Hoc communication mode according to the related art. Referring to FIG. 1A, a plurality of wireless terminals, such as a PC 11, a notebook computer 12, and a multifunctional device 13, directly communicate with each other without passing through a central management device.

FIG. 1B shows a diagram illustrating a wireless network system employing an infrastructure communication mode according to the related art.

Referring to FIG. 1B, a communication infrastructure 20 is a wired communication network formed of various communication terminals such as a PC and a server. The communication infrastructure 20 is connected to an access point 24. As described above, the access point 24 is a communication bridge between the communication infrastructure 20 and wireless communication terminals. As shown in FIG. 1B, access point 24 also connects to wireless terminals such as a personal computer (PC) 30, and a multifunctional device 40. The wireless terminals indirectly communicate with each other through access point 24 based on an infrastructure communication mode.

The Ad-Hoc communication mode provides superior mobility of wireless terminals 11, 12 and 13 because communication infrastructure is not connected to the wireless communication network. Accordingly, a user can use a wireless terminal, such as a notebook computer 12, at any location within a predetermined communication range. However, the Ad-Hoc communication mode has unstable link characteristics. That is, transmission distance and transmission bandwidth are limited, and the wireless signals are subject to interference. Also, a security problem may arise because the Ad-Hoc communication mode allows multiple links. The infrastructure communication mode provides a wireless communication range much wider than the Ad-Hoc communication mode although based upon an existing communication infrastructure.

Accordingly, recently developed wireless network cards generally support both Ad-Hoc communication mode and infrastructure communication mode, with the user being able to select which mode. Meanwhile, if access point 24 is turned-off, or under malfunction caused by radio interference, or if a wireless communication terminal is out of communication range of access point 24, the communication between the wireless terminals is interrupted.

In order to re-establish communication, access point 24 must be turned-on again or the wireless communication terminal moved into communication range of the access point 24. If the wireless network card of the wireless communication terminal supports the Ad-Hoc communication mode, the user may change current communication mode, which is the infrastructure communication mode, to the Ad-Hoc communication mode in order to communicate with a corresponding wireless terminal. In order to communicate with a corresponding wireless terminal by switching communication mode to the Ad-Hoc communication mode, user must newly assign necessary parameters of the corresponding wireless terminal such as Media Access Control (MAC) address, Service Set Identifier (SSID) and Basic Service Set Identifier (BSSID). Furthermore, if the access point malfunctions while transmitting data, the data must be retransmitted to the corresponding wireless terminal after switching from the infrastructure communication mode to the Ad-Hoc communication mode.

### SUMMARY OF THE INVENTION

Accordingly, an aspect of the present invention provides a terminal for automatically changing communication mode to an Ad-Hoc communication mode for reopening communication when an access point malfunction is detected. The terminal being operable over a wireless network.

In accordance with another aspect of the present invention, there is provided a terminal comprising a wireless communication module for communicating with a corresponding terminal through an access point connected to a communication infrastructure. The terminal further comprises a first memory for storing Ad-Hoc information previously establihed between the terminal and the corresponding terminal, and a controller for controlling the wireless communication module to communicate with the corresponding terminal based on an Ad-Hoc communication mode using the Ad-Hoc information stored in the first memory when the access point malfunctions.

The controller may determine that the access point has malfunctioned when the terminal does not receive a response packet from the corresponding terminal with a predetermined time after the terminal transmits a predetermined packet to the access point.

The terminal may further include a second memory for storing un-transmitted data when the access point malfunctions while transmitting data to the corresponding terminal.

The controller may control the wireless communication module to transmit the un-transmitted data stored in the second memory when the communication between the terminal and the corresponding terminal is re-established based on the Ad-Hoc communication mode.

The controller may transmit the Ad-Hoc information to the corresponding terminal while the terminal communicates with the corresponding terminal through the access point in order to change a communication mode to the Ad-Hoc communication mode when the access point has malfunctioned.

The Ad-Hoc mode information may include at least one of a media access control (MAC) address of a correspondent terminal, a MAC address of the terminal, a service set identifier (SSID), a basic service set identifier (BSSID) and a signal channel number.

In accordance with another aspect of the present invention, there is a provided a wireless network system comprising an access point connected to a predetermined communication infrastructure, an image forming apparatus connected to the communication infrastructure through the access point, and a terminal for transmitting a predetermined printing object data to the image forming apparatus through the access point. The image forming apparatus and the terminal re-establish communication based on an Ad-Hoc communication mode when the access point has malfunctioned.

The terminal may transmit Ad-Hoc information used for the Ad-Hoc communication mode while the terminal communicates with the image forming apparatus through the access point such that the image forming apparatus communicates based on the Ad-Hoc communication mode using the transmitted Ad-Hoc information.

The Ad-Hoc information may include a MAC address of the image forming apparatus, a MAC address of the terminal, a SSID, a BSSID, and a signal channel number.

In accordance with still another aspect of the present invention, there is a provided a communication method of a terminal communicating with a corresponding terminal based on an infrastructure communication mode through an access point coupled to a communication infrastructure. The communication method comprises checking a communication state of the access point, extracting pre-stored Ad-Hoc information when the access point has malfunctioned, and re-establishing an Ad-Hoc communication mode between the terminal and the corresponding terminal using the extracted Ad-Hoc information.

The Ad-Hoc information may include a MAC address of the correspondent node, a MAC address of the terminal, a SSID, a BSSID, and a signal channel number.

Checking the communication state of the access point may comprise transmitting a predetermined packet to the access point, determining whether a response packet of the transmitted packet is received within a predetermined time, and deciding that the access point has malfunctioned when the response packet is not received within the predetermined time.

The communication method may further comprise storing un-transmitted data when a portion of data is not transmitted to the terminal due to access point malfunction, and transmitting the un-transmitted data to the terminal when the communication to the terminal is re-established based on the Ad-Hoc communication mode.

The communication method may further comprise transmitting the Ad-Hoc information to the corresponding terminal through the access point while the terminal communicates with the corresponding terminal based on the infrastructure communication mode.

In accordance with yet another aspect of the present invention, there is provided a computer readable medium having stored thereon instructions for automatically changing a communication operating mode. The instructions for automatically changing a communication operating mode comprise instructions for causing a terminal to communicate with a corresponding terminal based on an infrastructure communication mode through an access point coupled to a communication infrastructure, instructions for checking a communication state of the access point, instructions for extracting pre-stored Ad-Hoc information when the access point has malfunctioned, and instructions for re-establishing communication between the terminal and the corresponding terminal based on an Ad-Hoc communication mode using the extracted Ad-Hoc information.

### BRIEF DESCRIPTION OF THE DRAWINGS

The above aspects and exemplary features of the present invention will be more apparent by describing certain exemplary embodiments of the present invention with reference to the accompanying drawings, in which:

FIG. 1A illustrates a view showing a wireless communication system employing an Ad-Hoc communication mode according to the related art;

FIG. 1B shows a diagram illustrating a wireless network system employing an infrastructure communication mode according to the related art;

FIG. 2 shows a block diagram illustrating a terminal according to an embodiment of the present invention;

FIG. 3 illustrates a diagram showing a structure of an auto-switch request packet transmitted from one terminal to a corresponding terminal according to an embodiment of the present invention;

FIG. 4 shows a block diagram illustrating a wireless network system according an embodiment of the present invention; and

FIG. 5 shows a flowchart of a method of automatically changing a communication mode according to an embodiment of the present invention.

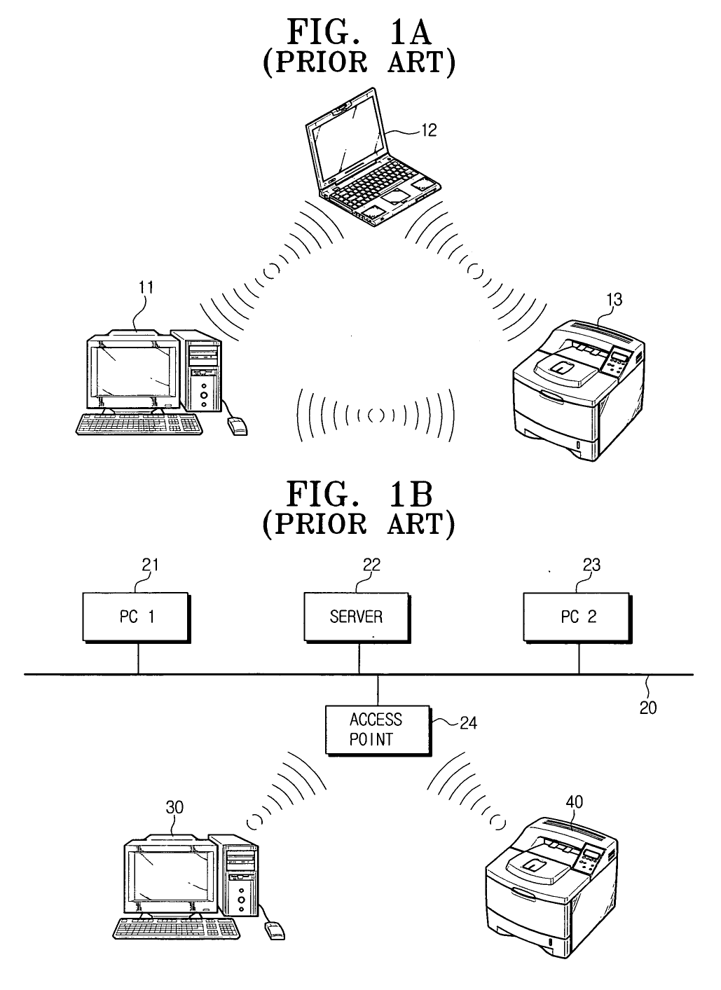

Throughout the drawings, like reference numbers should be understood to refer to like elements, features, and structures.

### DETAILED DESCRIPTION OF EXEMPLARY EMBODIMENTS

Exemplary embodiments of the present invention will now be described in greater detail with reference to the accompanying drawings. The matters exemplified in this description are provided to assist in a comprehensive understanding of various embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

FIG. 2 shows a block diagram illustrating a terminal according to an embodiment of the present invention. Referring to FIG. 2, terminal 100 comprises a wireless communication module 10, a controller 120, a first memory 130, and a second memory 140.

The wireless communication module 10 performs wireless communication with a corresponding terminal (not shown) directly and indirectly. That is, the wireless communication module 10 indirectly communicates with a corresponding terminal through an access point (not shown) in an infrastructure communication mode, and the wireless communication module 110 directly communicates with the corresponding terminal in an Ad-Hoc communication mode.

The wireless communication module 110 communicates with one of the corresponding terminals and access point according to a predetermined wireless network protocol. Standards of the wireless network protocol are classified into, for example, IEEE 802. 11 of the U.S.A., Hyper LAN of Europe, and MMAC-PC of Japan. The IEEE 802.11 standard is widely used in U.S.A. and Asia, and is further classified into IEEE 802.11a, IEEE 802.11b and IEEE 802.11g. A user of the terminal supporting such a wireless network protocol establishes a predetermined wireless network protocol according to a communication profile, such as a service set identification (SSID), and type of channel and security. In order to communicate based on the predetermined wireless network protocol, the wireless communication module 110 may comprise a plurality of wireless network cards according to each communication protocol, and may comprise a single network card when IEEE 802.11b or 802.11g is used. The IEEE 802.11b or 802.11g are compatible to other protocols.

Controller 120 determines whether a communication between the wireless communication module 110 and the access point is normal or abnormal, and directs change in a communication mode of the wireless communication module 110 from an infrastructure communication mode to the Ad-Hoc communication mode according to the result of the determination. That is, controller 120 determines that an access point has malfunctioned when a response packet of a predetermined transmitted packet is not received within a predetermined time. Controller 120 may test the access point by transmitting a predetermined data packet to the access points when the wireless communication module 110 is not transmitting data packets.

In order to change a communication mode from an infrastructure communication mode to an Ad-Hoc communication mode, first memory 130 stores Ad-Hoc information required for the Ad-Hoc communication mode. The Ad-Hoc information may be a MAC address of a corresponding terminal, a MAC address of terminal 100, a service set identifier (SSID), a basic service set identifier (BSSID), and a signal channel number. Among these the SSID is an identification of a communication network between the terminal and the corresponding terminal, and the BSSID is an identification used for identifying the corresponding terminal. The SSID, the channel number, and the MAC address may be set by a user or an existing SSID; an existing channel number and an existing MAC address used in the infrastructure communication mode may be used without modification. The BSSID is randomly generated in a MAC layer, and the generated BSSID is transmitted to the corresponding terminal when the 802.11 standard is employed.

In order to communicate based on the Ad-Hoc communication mode, the corresponding terminal must store the Ad-Hoc information. Accordingly, controller 120 generates an auto-switch request packet packetized with the Ad-Hoc information and transmits the auto-switch request packet to the corresponding terminal while terminals are communicating with each other through an access point based on the infrastructure communication mode.

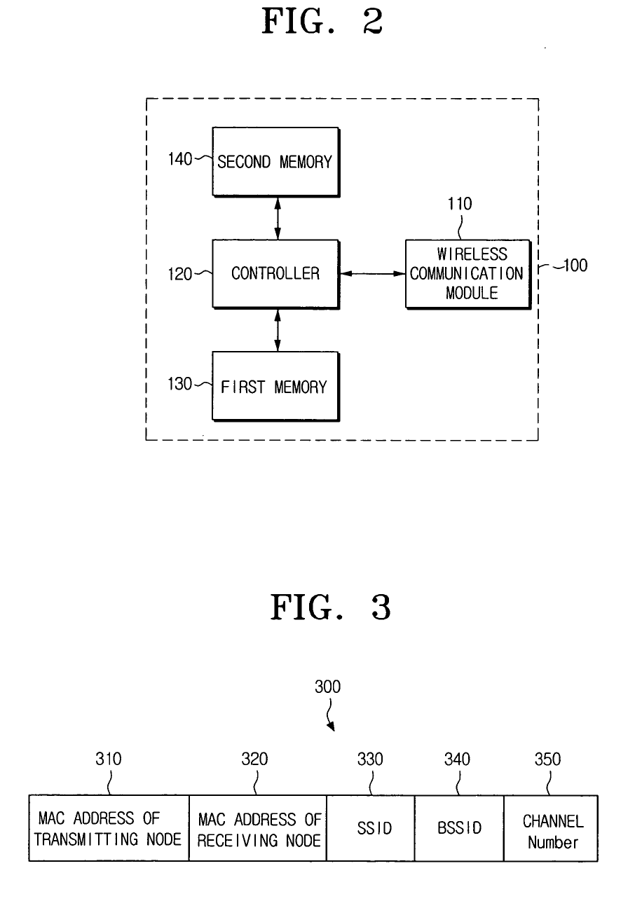

FIG. 3 illustrates a diagram showing a structure of an auto-switch request packet transmitted from a terminal 100 to a corresponding terminal according to an embodiment of the present invention. Referring to FIG. 3, the auto-switch request packet 300 includes Ad-Hoc information such as the MAC address of a transmitting terminal 310, the MAC address of a receiving terminal 320, that is, the MAC address of a corresponding terminal, a SSID 330, a BSSID 340, and a signal channel number 350. The auto-switch request packet 300 having Ad-Hoc information is transmitted to the corresponding terminal. When the corresponding terminal receives the auto-switch request packet 300, the corresponding terminal transmits a response packet to terminal 100 and stores the Ad-Hoc information in the auto-switch request packet within its own memory (not shown). Accordingly, the corresponding terminal automatically changes the communication mode to the Ad-Hoc communication mode when the access point malfunctions.

Meanwhile, information used in the infrastructure communication mode may be used as Ad-Hoc information without modification, excepting BSSID. Also, a user may directly set the Ad-Hoc information.

If a portion of the transmitting data is not transmitted due to access point malfunction while the transmitting data is transmitted to the corresponding terminal, controller 120 stores the un-transmitted data in second memory 140. When communication with the corresponding terminal is re-established by switching the communication mode to the Ad-Hoc communication mode, the un-transmitted data stored in second memory 140 is automatically transmitted to the corresponding terminal. Therefore, a user does not need to input a command to transmit the un-transmitted data to the corresponding terminal.

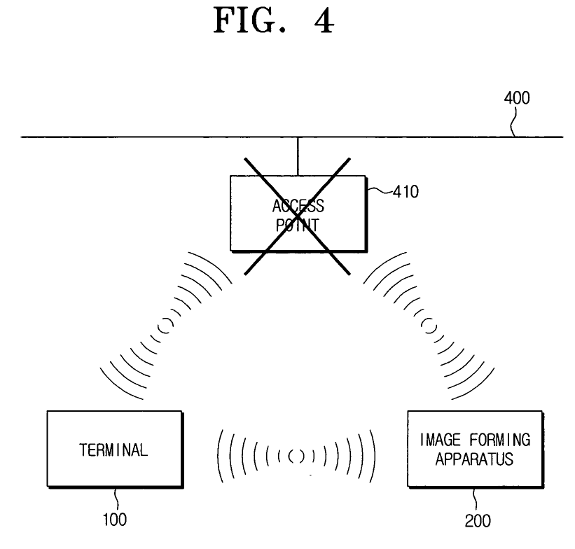

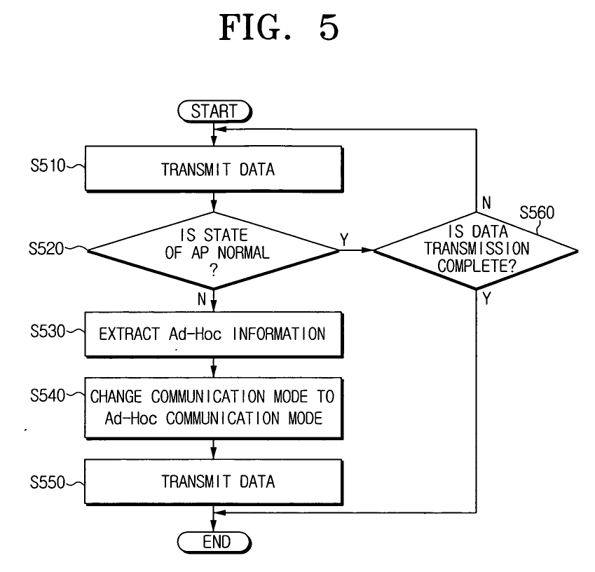

FIG. 4 shows a block diagram illustrating a wireless network system according an embodiment of the present invention. Referring to FIG. 4, the wireless network system in accordance with an exemplary embodiment of the present invention comprises an access point 410 connected to a communication infrastructure 400, a terminal 100, and an image forming apparatus 200. Image forming apparatus 200 is an example of a corresponding terminal.

Referring to FIG. 4, terminal 100 and image forming apparatus 200 automatically change communication mode to the Ad-Hoc communication mode when access point 410 has malfunctioned. After changing communication mode to the Ad-Hoc communication mode, terminal 100 and image forming apparatus 200 re-communicate with each other based on the Ad-Hoc communication mode. That is, terminal 100 retransmits the un-transmitted portion of printing object data to image forming apparatus 200. Image forming apparatus 200 receives the retransmitted printing object data and performs the printing operation.

As described above, terminal 100 and image forming apparatus 200 must store the Ad-Hoc information to communicate with each other based on the Ad-Hoc communication mode. In order to store the Ad-Hoc information, terminal 100 and image forming apparatus 200 share the Ad-Hoc information by communicating with each other based on the infrastructure communication mode when access point 410 is in normal operation. That is, auto-switch request packet 300 is transmitted to image forming apparatus 200, or the user directly inputs the Ad-Hoc information to image forming apparatus 200.

FIG. 5 shows a flowchart of a method of automatically changing a communication mode according to an embodiment of the present invention. Referring to FIG. 5, when a user transmits predetermined data using terminal 100 in operation S510, controller 120 checks the state of access point 410 in operation S520.

If access point 410 is in a normal state, terminal 100 continuously transmits data until the data transmission is completed in operation S560. On the other hand, if access point 410 is in an abnormal state, controller 120 extracts the Ad-Hoc information from the first memory 130 in operation S530. The communication mode is changed to the Ad-Hoc communication mode by using the extracted Ad-Hoc information in operation S540. The corresponding terminal, such as image forming apparatus 200, also changes communication mode to the Ad-Hoc communication mode by using the Ad-Hoc information stored in its own memory.

As a result, terminal 100 and corresponding terminal 200 re-establish communication based on the Ad-Hoc communication mode, and un-transmitted data is transmitted from terminal 100 to the corresponding terminal 200 in operation S550. That is, a user is not required to input a supplementary command or to provide additional information for the communication mode to change. As described above, in order to automatically change communication mode to the Ad-Hoc communication mode, Ad-Hoc information is stored in terminal 100 and image forming apparatus 200 before malfunction occurs.

As described above, a terminal according to an exemplary embodiment of the present invention automatically changes communication mode to an Ad-Hoc communication mode when a terminal and a corresponding terminal are unable to communicate with each other using the infrastructure communication mode because, for example, of an access point malfunction. Since the terminal automatically changes communication mode, communication between the terminal and the corresponding terminal is re-established after switching the communication mode to the Ad-Hoc communication mode. A user need not manually change the communication mode or set a profile of the communication mode for the change to occur. If an access point malfunctions while transmitting printing object data to the image forming apparatus for performing a printing operation, the printing operation can be continuously performed without manually checking states of an access point, such as a power state, a LAN connection state, location of an access point and a signal state. Thus, a user's convenience and printing operation efficiency is maximized.

The foregoing embodiments and advantages are exemplary and are not to be construed as limiting the present invention. The forgoing embodiments can be implemented in computer readable medium having stored thereon instructions for automatically changing a communication operating mode in accordance with aspects of the present invention. The present teaching can be readily applied to other types of apparatuses. Also, the description of the embodiments of the present invention is intended to be illustrative, and not to limit the scope of the claims. While the present invention has been particularly shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A terminal comprising:
a wireless communication module for performing a communication with a corresponding terminal through an access point coupled to a communication infrastructure;
a first memory for storing an Ad-Hoc information previously established between the terminal and the corresponding terminal; and
a controller for controlling the wireless communication module to communicate with the corresponding terminal based on an Ad-Hoc communication mode using the Ad-Hoc information stored in the first memory.

2. The terminal of claim 1, wherein the controller determines that the access point has malfunctioned when the terminal does not receive a response packet from the corresponding terminal for a predetermined time after the terminal transmits a packet to the access point.

3. The terminal of claim 2, further comprising a second memory for storing un-transmitted data when the controller has determined that the access point has malfunctioned during data transmission to the corresponding terminal.

4. The terminal of claim 3, wherein the controller controls the wireless communication module to transmit the un-transmitted data stored in the second memory when communication between the terminal and the corresponding terminal is re-established based on the Ad-Hoc communication mode.

5. The terminal of claim 1, wherein the controller transmits the Ad-Hoc information to the corresponding terminal while the terminal communicates with the corresponding terminal through the access point in order to change communication mode to the Ad-Hoc communication mode when the access point has malfunctioned.

6. The terminal of claim 1, wherein the Ad-Hoc mode information comprises at least one of a media access control (MAC) address of a corresponding terminal, a MAC address of the terminal, a service set identifier (SSID), a basic service set identifier (BSSID) and a signal channel number.

7. A wireless network system comprising:
an access point coupled to a communication infrastructure;
an image forming apparatus coupled to the communication infrastructure through the access point; and
a terminal for transmitting a printing object data to the image forming apparatus through the access point,
wherein the image forming apparatus and the terminal re-establish communication based on an Ad-Hoc communication mode when the access point has malfunctioned.

8. The wireless network system of claim 7, wherein the terminal transmits Ad-Hoc information used for the Ad-Hoc communication mode while the terminal communicates with the image forming apparatus through the access point for the image forming apparatus to perform a communication based on the Ad-Hoc communication mode using the transmitted Ad-Hoc information.

9. The wireless network system of claim 7, wherein the Ad-Hoc information comprises a MAC address of the image forming apparatus, a MAC address of the terminal, a SSID, a BSSID and a signal channel number.

10. A communication method comprising:
causing a terminal to communicate with a corresponding terminal based on an infrastructure communication mode through an access point coupled to a communication infrastructure;
checking a communication state of the access point;
extracting pre-stored Ad-Hoc information when the access point has malfunctioned; and
re-establishing communication between the terminal and the corresponding terminal based on an Ad-Hoc communication mode using the extracted Ad-Hoc information.

11. The communication method of claim 10, wherein the Ad-Hoc information comprises a MAC address of the corresponding node, a MAC address of the terminal, a SSID, a BSSID and a signal channel number.

12. The communication method of claim 10, wherein the checking of the communication state of the access point comprises:
transmitting a packet to the access point;
determining whether a response packet is received within a predetermined time; and
deciding that the access point has malfunctioned when the response packet is not received within the predetermined time.

13. The communication method of claim 10, further comprising:
storing un-transmitted data when a portion of data is not transmitted to the corresponding terminal due to access point malfunction; and
transmitting the un-transmitted data to the corresponding terminal when the communication to the terminal is re-established based on the Ad-Hoc communication mode.

14. The communication method of claim 10, further comprising:
transmitting the Ad-Hoc information to the corresponding terminal through the access point while the terminal communicates with the corresponding terminal based on the infrastructure communication mode.

15. A computer readable medium for storing thereon instructions for automatically changing a communication operating mode, the computer readable medium comprising:
instructions for causing a terminal to communicate with a corresponding terminal based on an infrastructure communication mode through an access point coupled to a communication infrastructure;
instructions for checking a communication state of the access point;
instructions for extracting pre-stored Ad-Hoc information when the access point has malfunctioned; and
instructions for re-establishing communication between the terminal and the corresponding terminal based on an Ad-Hoc communication mode using the extracted Ad-Hoc information.

16. The computer readable medium as claimed in claim 15, wherein the Ad-Hoc information comprises a MAC address of the corresponding node, a MAC address of the terminal, a SSID, a BSSID and a signal channel number.

17. The computer readable medium as claimed in claim 15, wherein instructions for checking the communication state of the access point comprise:
instructions for transmitting a packet to the access point;
instructions for determining whether a response packet is received within a predetermined time; and
instructions for deciding that the access point has malfunctioned when the response packet is not received within the predetermined time.

18. The computer readable medium as claimed in claim 15, further comprising:
instructions for storing un-transmitted data when a portion of data is not transmitted to the corresponding terminal due to access point malfunction; and
instructions for transmitting the un-transmitted data to the corresponding terminal when the communication to the terminal is re-established based on the Ad-Hoc communication mode.

19. The computer readable medium as claimed in claim 15, further comprising:
instructions for transmitting the Ad-Hoc information to the corresponding terminal through the access point while the terminal communicates with the corresponding terminal based on the infrastructure communication mode.
